(19) United States
(12) Patent Application Publication
(10) Pub. No.: US 2012/0210749 A1
(43) Pub. Date: Aug. 23, 2012

(54) ION EXCHANGE USING NITRATES AND NITRITES TO PREVENT OPTICAL DEGRADATION OF GLASS

(76) Inventors: Jiangwei Feng, Painted Post, NY (US); Kenneth Edward Hrdina, Horseheads, NY (US); Yawei Sun, Horseheads, NY (US)

(21) Appl. No.: 13/031,860

(22) Filed: Feb. 22, 2011

(51) Int. Cl. C03C 21/00; C09K 3/00; G02B 1/11; B82Y 30/00

(52) U.S. Cl. 65/30.14; 359/601; 252/184; 977/773

(57) ABSTRACT

A method of chemically strengthening a glass article having an antireflective coating in which the reflectance of the coating is not significantly degraded by chemical strengthening. The glass article having the antireflective coating is strengthened using an ion exchange medium that comprises potassium nitrate and at least about 5 wt % potassium nitrite. Also provided are a glass article having an antireflective surface that is not degraded by such ion exchange and an ion exchange medium comprising potassium nitrate and at least about 5 wt % potassium nitrite.

### BACKGROUND

Glasses that combine high damage resistance, low thickness, and pristine surface quality are used as cover glass for consumer electronics applications, such as televisions, information terminals (IT), and hand-held devices. These glasses are often chemically strengthened, typically by ion exchange, to increase their resistance to damage during use.

In addition, an anti-reflective (AR) coating is sometimes applied to the surface of such cover glasses to reduce the reflectance of visible light from the substrate and enhance the transmittance of light from the device display.

Chemical strengthening of glass articles is sometimes carried out after the application of a functional coating such as, for example, an antireflective coating. In some instances, the antireflective coating is not compatible with the ion exchange process. Consequently, the antireflective properties of the antireflective coating undergo significant degradation as a result of ion exchange.

### SUMMARY

A method of chemically strengthening a glass article having an antireflective coating in which the reflectance of the coating is not significantly degraded is provided. The glass article having the antireflective coating is strengthened using an ion exchange medium that comprises potassium nitrate (KNO₃) and at least about 5 wt % potassium nitrite (KNO₂). Also provided are a glass article having an antireflective surface that is not degraded and an ion exchange medium comprising potassium nitrate and at least about 5 wt % potassium nitrite.

Accordingly, one aspect of the disclosure is to provide a glass article. The glass article comprises a chemically strengthened transparent glass substrate and an antireflective layer disposed on a surface of the transparent glass substrate. The antireflective layer comprises a plurality of nanoparticles and has a minimum reflectance of less than about 2% between about 400 nm and about 800 nm.

A second aspect of the disclosure is to provide a method of strengthening a glass article. The method comprises contacting the glass article with an ion exchange medium comprising potassium nitrate and at least about 5 wt % potassium nitrite and forming a compressive stress layer extending from at least one surface of the glass article to depth of layer in the glass.

A third aspect of the disclosure is to provide an ion exchange medium. The ion exchange medium comprises potassium nitrate and at least about 5 wt % potassium nitrite.

These and other aspects, advantages, and salient features will become apparent from the following detailed description, the accompanying drawings, and the appended claims.

### BRIEF DESCRIPTION OF THE DRAWINGS

FIG. 1 is a plot of reflectance before and after ion exchange of glass sheets having antireflective coatings on two opposing surfaces;

FIG. 2 is a plot of reflectance as a function of ion exchange bath composition;

FIG. 3 is a plot of compressive stress and depth of layer as functions of ion exchange bath composition for glass sheets having antireflective coatings;

FIG. 4 is a plot of potassium ion profile in ion exchanged glass sheets having an antireflective coating; and

FIG. 5 is a plot of nitrogen ion profile in ion exchanged glass sheets having an antireflective coating.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range as well as any ranges therebetween. As used herein, the indefinite articles “a,” “an,” and the corresponding definite article “the” mean “at least one” or “one or more,” unless otherwise specified.

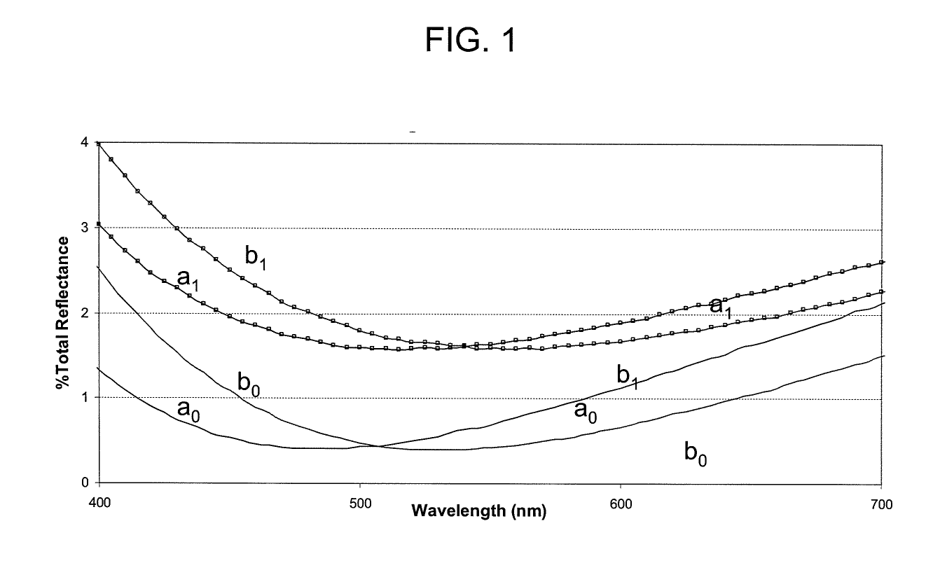

Referring to the drawings in general and to FIG. 1 in particular, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

Glasses that combine high damage resistance, low thickness, and pristine surface quality are used as cover glass for consumer electronics applications, such as televisions, information terminals (IT), and hand-held devices. Such applications often require an anti-reflective (AR) coating to reduce the reflectance of visible light from the substrate and enhance the transmittance of light from the device display. Such AR coatings can be deposited by several means such as physical vapor deposition, chemical vapor deposition, ion- or plasma assisted vapor deposition (e.g., electron-beam deposition, PVD, CVD, IAD), or the like. Because mass-production of large size articles by these means requires expensive vacuum chamber equipment, deposition of AR coatings by sol-gel processes provides an alternative technology. Sol-gel coating techniques are generally carried out under ambient pressure and atmosphere and require curing by either ultraviolet radiation or heating.

Antireflective and antiglare treatments represent different approaches to improve or optimize viewing or readability of an image through a viewing screen, display window, and/or cover glass. Antiglare coatings use a diffusion mechanism to breakup light from an external source (for example, the sun or room lighting) reflected from the surface of an article, such as a viewing screen or display window, whereas antireflection addresses both internal and external sources of light that are transmitted through a display window. As light passes from one medium to another (for example, from air to a solid layer or between solid layers) the difference in index of refraction or materials in the layers (air/solid or solid/solid) between the layers creates transitional phase differences that increase the amount of light that is reflected. These reflections are cumulative and can “wash out” the display, making the image unreadable without increasing the light output of the display which is undesirable because this requires increasing the power to the display. This increased power requirements lead to shortened battery life for portable display items.

In some applications, chemical strengthening of glass articles is carried out after the application of a functional coating such as, for example, antiglare or antireflective coatings. Such chemical strengthening is, in many instances, achieved by an ion exchange process in which metal cations (ions) in the glass are replaced by larger metal ions of the same valence. This replacement of a smaller ionic specie with a larger ionic specie occurs to a depth (depth of layer) beneath the surface, and creates a compressive stress (CS) in the region where such ion exchange occurs. This compressive layer prevents the propagation of flaws or cracks from the surface into the bulk of the glass and thus improves the resistance of the glass to damage from external sources (e.g., from impact). The compressive stress in the region at or near the surface is balanced by a central tension within the bulk of the glass. In one non-limiting example, potassium ions (K⁺) replace smaller sodium ions (Na⁺) in the glass to a depth of layer. The ion exchange process is usually carried out by contacting the glass article with an ion exchange medium, such as a paste or fluid, containing the larger metal ion. For example, the ion exchange process may be carried out by immersing the glass article in a molten salt bath containing the larger metal ion (e.g., K⁺).

Some sol-gel deposited coatings are not degraded by the ion exchange process, and retain their respective optical and mechanical properties. For example, U.S. Provisional Patent Application No. 61/348,474, filed May 26, 2010, and entitled “Ion-Exchanging an AR Coated Glass and Process,” describes a process in which an ion exchangeable glass sheet is coated with a sol-gel to generate a coating which is then cured to provide an adherent antireflective coating on the glass. The glass sheet and AR coating then undergo ion exchange to impart a compressive stress in the glass. The AR coatings described in this application were 1-layer, 3-layer and 4-layer coatings deposited using a sol-gel consisting of SiO₂, Al₂O₃, TiO₂, transition metal oxides (e.g., oxides of Ti, Hf, Gd, and Zr), and an alkoxide of silicon and/or titanium in an acidic alcoholic medium that may contain alkali metal salts (generally chlorides, nitrates or acetates) of Ti and/or Al or other metals. The sol-gel described in U.S. Provisional Patent Application No. 61/348,474 may be either thixotropic or non-thixotropic, and may be applied as either a single layer or a plurality of layers by dipping, spraying or other means known in the art.

However, other types of antireflective coatings are not compatible with ion exchange processes. In particular, such coatings are not compatible with ion exchange using a pure potassium nitrate (KNO₃) molten salt bath as the ion exchange medium. In these instances, the reflectance of the AR coating degrades as a result of the ion exchange process. The reflectance degradation of glass sheet having antireflective coating on two opposing surfaces is shown in FIG. 1. The reflectance data shown in FIG. 1 were obtained for AR coatings comprising hollow silica nanoparticles and fragments thereof. These coatings were formed by dip-coating the glass sheet in a dispersion followed by curing. Reflectance (percent total reflectance) was measured for 490 nm and 535 nm incident radiation, respectively, before (a₀, b₀) and after (a₁, b₁) ion exchange in an ion exchange bath of pure (100% by weight) KNO₃. In these instances, ion exchange with KNO₃ caused the reflectance of the AR surfaces to increase by at least 100%.

In one aspect, the problem of reflectance degradation resulting from the ion exchange in glass articles having such antireflective surfaces is addressed by providing a chemically strengthened glass article that comprises a transparent glass substrate and an antireflective (AR) layer or coating disposed on at least one surface of the glass substrate. The glass substrate may be any ion exchangeable glass such as, but not limited to, soda lime glasses, alkali aluminosilicate glasses, alkali aluminoborosilicate glasses, or the like. As used herein, the terms “layer” and “coating” refer to a discrete layer that is not integral to the glass substrate, unless otherwise specified. The AR coating has a nanostructure which, in some embodiments, comprises a plurality of hollow nanospheres. As used herein, the term “nanospheres” includes spherical and near-spherical (e.g., ellipsoidal) nanoparticles and fragments thereof. In still other embodiments, the nanostructure comprises a combination or mixture of nanospheres, nano-rods, worm-like (i.e., having a central axis that deviates from a straight line) nanoparticles, or the like. The hollow nanospheres, nano-rods, and/or worm-like nanoparticles may comprise an inorganic oxide such as lithium fluoride, calcium fluoride, barium fluoride, magnesium fluoride, titanium dioxide, zirconium oxide, antimony doped tin oxide, tin oxide, aluminum oxide, silicon dioxide, combinations thereof, and mixtures thereof. In particular embodiments, the inorganic oxide is silica (SiO₂) and, in some embodiments, the nanoparticles (i.e., nanospheres, nano-rods, worm-like nanoparticles, etc.) comprise at least 90 wt % SiO₂.

The antireflective coating is such that, the minimum reflectance measured at a wavelength between 400 and 800 nm (the visible light region) for one surface of the glass article having the AR coating is less than or equal to about 2%, in some embodiments, less than or equal to about 1.5%, and, in other embodiments, less than or equal to about 1%, as measured by reflectometry or colorimetry methods that are known in the art. Generally, the reflection has a slope or a curve over the 400-800 nm wavelength range, as shown, for example, in FIG. 1. The minimum in the reflection, which is defined as either a minimum in a curve or the lower end of the slope, is at a wavelength in the range from about 400 nm up to about 800 nm. The optimal wavelength for the human eye is a minimum reflection around 550 nm, as this is the wavelength (i.e., color) at which the human eye is most sensitive. In those instances where a color shade is desired, however, a minimum at lower or higher wavelength can be selected. The surface (or surfaces) of the glass article having an antireflective coating does not exhibit degradation in reflectance of light having a wavelength of between 400 nm and 800 nm after the glass article has undergone ion exchange; i.e., the reflectance of one or more surfaces of the glass article is substantially unchanged by subsequent strengthening of the glass article by ion exchange.

The antireflective coatings described herein have an arithmetic average roughness in a range from about 2 nm to about 300 nm and, in some embodiments, in a range from about 10 nm to about 50 nm. The antireflective coating has a thickness of at least 50 nm. In some embodiments, the antireflective coating has a thickness in a range from about 50 nm up to about 150 nm and, in other embodiments, in a range from about 50 nm up to about 250 nm.

In some embodiments, the antireflective surface is formed by a sol-gel process in which the glass substrate is coated with a dispersion containing a binder, solvent, and nanoparticles. The glass substrate may be coated using those means used in he art, such as dip-coating, meniscus coating, spray coating, roll coating, spin coating, or the like. In those instances where the nanoparticles are spherical or near-spherical, the nanoparticles may comprise a polymeric core and a silica shell. After dip-coating the glass substrate, the polymer core is removed from the nanoparticles by curing at a temperature ranging from about 400° C. up to about 500° C., thus forming hollow silica particles and bonding the particles to the surface of the glass substrate. Such antireflective coatings and methods of making such coatings are described in European Patent Application EP 1 674 891 A1, filed Dec. 23, 2004; and WO 2007/093339, having a filing date of Feb. 12, 2007, the contents of which are incorporated herein in their entirety.

Following formation of the antireflective layer, the glass article is chemically strengthened by ion exchange with an ion exchange medium, such as an ion exchange bath, comprising potassium nitrate (KNO₃) and at least about 5 wt % potassium nitrite (KNO₂). In some embodiments, the ion exchange bath may comprise up to about 50 wt % KNO₂, in other embodiments, up to about 75 wt % KNO₂, and, in other embodiments, up to about 75 wt % KNO₂. In some embodiments, the ion exchange medium or bath is a molten salt bath comprising KNO₃ and at least about 5 wt % KNO₂. This molten salt bath may be heated at a temperature in a range from about 390° C. up to about 550° C.

Potassium nitrate has two major decomposition products: potassium nitrite and potassium oxide (K₂O). At lower temperatures (650°-750°, KNO₃ decomposes to form the nitrite according to the reaction

KNO₃→KNO₂+½O₂
The addition of potassium nitrite to a molten salt ion exchange bath changes the melting point of the ion exchange bath. As the potassium nitrite content exceeds about 20 wt %, the melting point of the salt bath begins to increase.

The addition of potassium nitrite to the ion exchange bath reduces the degree of reflectance degradation without compromising the compressive stress and depth of layer under such compressive stress. As seen in FIG. 1 and described hereinabove, ion exchange in a “pure” KNO₃ (99.5 wt % KNO₃, 0.5 wt % silicic acid) molten salt bath comprising an alkali aluminosilicate glass (CORNING™ glass code 2317, nominal composition: 66.16 mol % SiO₂; 10.29 mol % Al₂O₃; 14 mol % Na₂O; 2.45 mol % K₂O; 0.6 mol % B₂O₃; 0.21 mol % SnO₂; 0.58 mol % CaO; 5.7 mol % MgO; 0.01 mol % ZrO₂; 0.008 mol % Fe₂O₃) substrate having an antireflective coating such as those described hereinabove on both major opposing surfaces results in significant of optical properties such as reflectance and transmission. The minimum reflectance of the glass article degrades from 0.4% to about 1.5%.

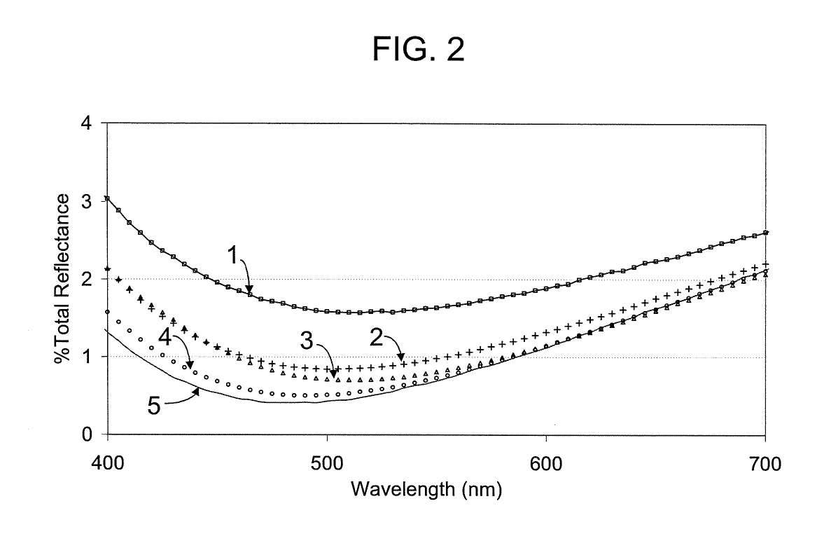

The effect of KNO₂ concentration in the ion exchange bath on the reflectance of glass articles following ion exchange is shown in FIG. 2. The data plotted in FIG. 2 was obtained for ion exchanged alkali aluminosilicate glass samples (CORNING™ glass code 2317) having antireflective coatings on opposing surfaces of the sample. The antireflective coatings were formed by dip-coating the glass substrates in a dispersion containing nano-particles having a polymer core and silica shell, followed by curing at a temperature ranging from about 400° C. up to about 500° C. to remove the polymer core and form hollow silica particles. The AR coated glass samples were ion exchanged by immersion in molten salt baths comprising 100 wt % KNO₃ (line 1 in FIG. 2), 75 wt % KNO₃/25 wt % KNO₂ (line 2 in FIG. 2), 50 wt % KNO₃/50 wt % KNO₂ (line 3 in FIG. 2), and 25 wt % KNO₃/75 wt % KNO₂ (line 4 in FIG. 2). Reflectance of the AR coated was measured for each sample following ion exchange. Reflectance was also measured for glass samples having the AR coating prior to ion exchange (line 5 in FIG. 2). The addition of KNO₂ to the KNO₃ ion exchange bath reduces the degradation of reflectance of AR coated glass. Higher KNO₂ concentration in the ion exchange bath results in less reflectance degradation. However, a yellow tint in the glass is produced by high KNO₂ concentrations (e.g., 75% KNO₂) in the ion exchange bath.

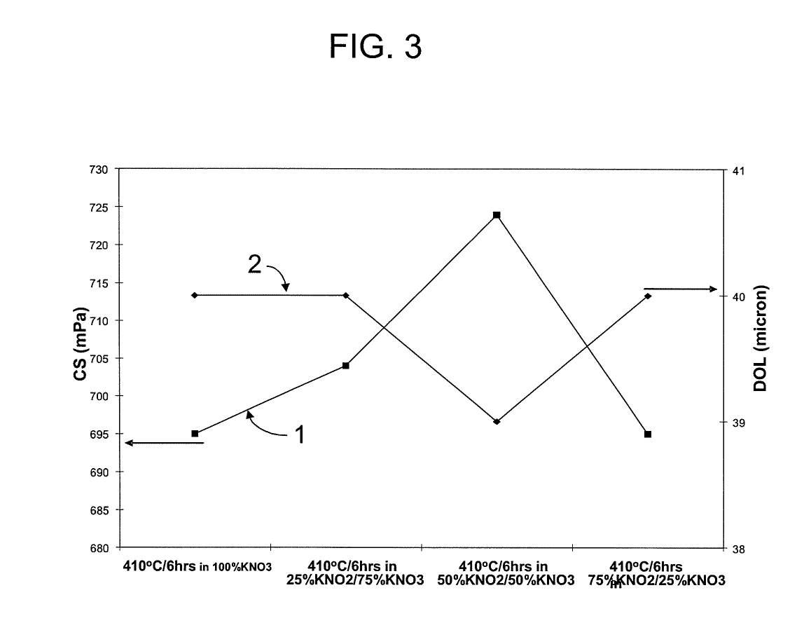

The effect of the presence of ion exchange in baths containing KNO₂ is shown in FIG. 3, in which compressive stress (CS; line 1 in FIG. 3) and depth of compressive layer (DOL; line 2 in FIG. 3) are plotted as functions of bath composition for alkali aluminosilicate glasses (CORNING™ glass code 2317) coated with the antireflective coating previously described hereinabove. The data plotted in FIG. 3 demonstrate that mixing KNO₂ into the ion exchange bath does not significantly affect on compressive stress and potassium ion depth of layer, which are indicators of mechanical strength of the glass.

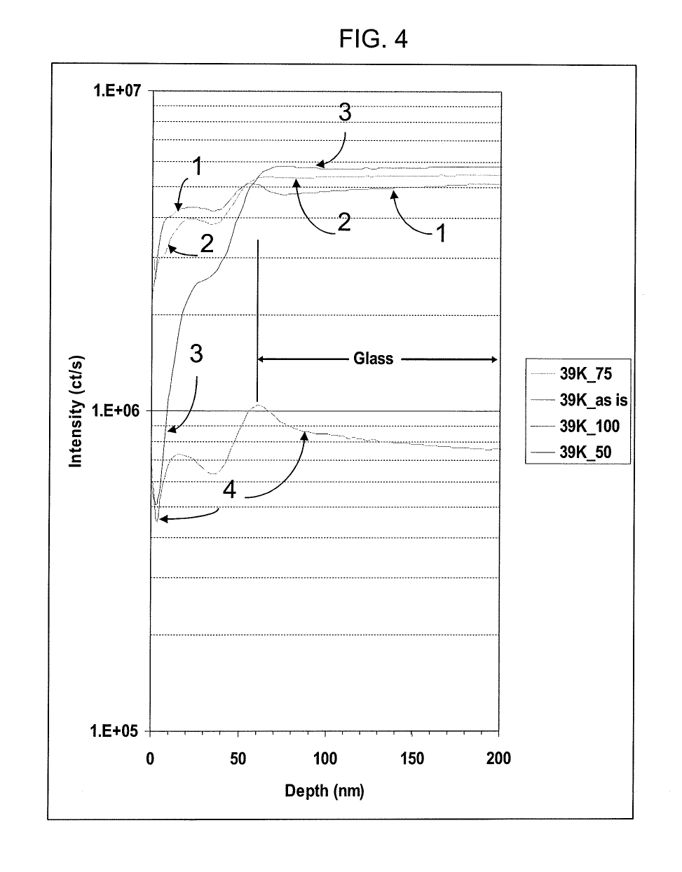

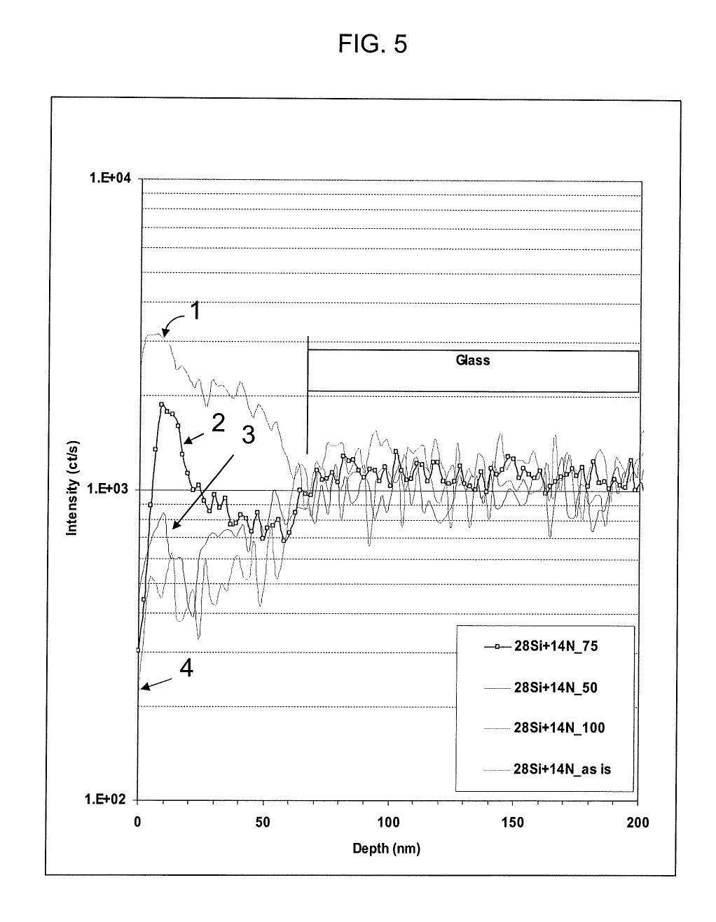

Potassium and nitrogen profiles in ion exchanged glasses having antireflective coatings were determined by secondary ion mass spectrometry (SIMS) and are plotted in FIGS. 4 and 5 respectively. The potassium and nitrogen profiles (expressed counts per second (ct/s), which are proportional to the actual concentration of these elements) are plotted, as a function of depth, expressed in nm, in FIGS. 4 and 5. Note that the profiles of potassium and sodium were measured through the depth of the AR coating across the interface between the AR coating and the glass substrate (line A in FIGS. 5 and 6), and 200 nm into the glass substrate. The glass samples that were studied comprised alkali aluminosilicate glasses (CORNING™ glass code 2317) coated with the antireflective coating previously described hereinabove. The samples were ion exchanged in ion exchange baths containing KNO₃ and KNO₂ of different composition: 100 wt % KNO₃ (line 1 in FIGS. 4 and 5); 75 wt % KNO₃ (line 2 in FIGS. 4 and 5); and 50 wt % KNO₃ (line 3 in FIGS. 4 and 5). Potassium and nitrogen profiles for AR-coated samples that did not subsequently undergo ion exchange are also plotted for comparison (line 4 in FIGS. 4 and 5). The SIMS measurements show that higher KNO₂ (i.e. lower KNO₃) concentrations in the ion exchange bath lead to lower potassium and nitrogen concentrations in the AR coating. Reduced amounts of K and N diffused into the AR coating will have less impact on the material properties (e.g., refractive index) of the AR coating and lead to less degradation of optical properties of the coatings.

In another aspect, a method of strengthening a glass article is provided. The method comprises contacting the glass article with an ion exchange medium comprising KNO₃ and at least 5 wt % KNO₂ and creating a compressive stress in a region of the glass article, wherein the region extends from a surface of the glass article to a depth of layer below the surface. The ion exchange medium may be a fluid such as an ion exchange bath or the like and, in particular, a molten salt ion exchange bath. In other embodiments, the ion exchange medium may be a paste comprising KNO₃ and at least 5 wt % KNO₂. In some embodiments, the method includes the step of providing the ion exchange medium.

In some embodiments, the method includes providing the glass article. In other embodiments, the method includes forming an antireflective coating, such as those described herein, on at least one surface of the glass article. In other embodiments, the method includes providing a glass article having such an antireflective coating on at least one surface of the glass article.

In the method described herein, the glass article may be any ion exchangeable glass such as, but not limited to, soda lime glasses, alkali aluminosilicate glasses, alkali aluminoborosilicate glasses, or the like. In some embodiments, the glass article may have an antireflective coating comprising a nanostructure, such as those previously described hereinabove, which may comprise a plurality of hollow nanospheres, nano-rods, worm-like nanoparticles, or the like, and combinations thereof. When the glass article is strengthened by the method described herein, the antireflective layer does not exhibit degradation in reflectance of light having a wavelength of between 400 nm and 800 nm after the glass article has undergone ion exchange; i.e., the reflectance of one or more surfaces of the glass article is substantially unchanged by subsequent strengthening of the glass article by ion exchange.

In another aspect, an ion exchange medium for strengthening such glass articles is provided. The ion exchange bath comprises KNO₃ and at least about 5 wt % KNO₂. In some embodiments, the ion exchange medium comprises up to about 85 wt % KNO₂ and, in other embodiments, up to about 75 wt % KNO₂. The ion exchange medium may further include silicic acid and, in some embodiments, up to about 1 wt % silicic acid. The ion exchange bath may, in some embodiments, be a molten salt bath, which is capable of ion exchange at temperatures ranging from about 390° C. to about 550° C. Alternatively the ion exchange bath may be a slurry or paste comprising KNO₃ and at least about 5 wt % KNO₂.

In some embodiments, the glass substrate described hereinabove comprises an alkali aluminosilicate glass or an alkali aluminoborosilicate glass. In one embodiment, the alkali aluminosilicate glass comprises alumina, at least one alkali metal and, in some embodiments, greater than 50 mol % SiO₂, in other embodiments, at least 58 mol % SiO₂, and in still other embodiments, at least 60 mol % SiO₂, wherein the ratio

$$\frac{{Al}_{2} {O}_{3} ( mol \% ) + {B}_{2} {O}_{3} ( mol \% )}{\sum alkali metal modifiers ( mol \% )} > 1 ,$$

where the modifiers are alkali metal oxides. This glass, in particular embodiments, comprises, consists essentially of, or consists of: about 58 mol % to about 72 mol % SiO₂; about 9 mol % to about 17 mol % Al₂O₃; about 2 mol % to about 12 mol % B₂O₃; about 8 mol % to about 16 mol % Na₂O; and 0 mol % to about 4 mol % K₂O, wherein the ratio

$$\frac{{Al}_{2} {O}_{3} ( mol \% ) + {B}_{2} {O}_{3} ( mol \% )}{\sum alkali metal modifiers ( mol \% )} > 1$$

where the modifiers are alkali metal oxides. In another embodiment, the alkali aluminosilicate glass comprises, consists essentially of, or consists of: about 61 mol % to about 75 mol % SiO₂; about 7 mol % to about 15 mol % Al₂O₃; 0 mol % to about 12 mol % B₂O₃; about 9 mol % to about 21 mol % Na₂O; 0 mol % to about 4 mol % K₂O; 0 mol % to about 7 mol % MgO; and 0 mol % to about 3 mol % CaO. In yet another embodiment, the alkali aluminosilicate glass comprises, consists essentially of, or consists of: about 60 mol % to about 70 mol % SiO₂; about 6 mol % to about 14 mol % Al₂O₃; 0 mol % to about 15 mol % B₂O₃; 0 mol % to about 15 mol % Li₂O; 0 mol % to about 20 mol % Na₂O; 0 mol % to about 10 mol % K₂O; 0 mol % to about 8 mol % MgO; 0 mol % to about 10 mol % CaO; 0 mol % to about 5 mol % ZrO₂; 0 mol % to about 1 mol % SnO₂; 0 mol % to about 1 mol % CeO₂; less than about 50 ppm As₂O₃; and less than about 50 ppm Sb₂O₃; wherein 12 mol %≦Li₂O+Na₂O+K₂O≦20 mol % and 0 mol %≦MgO+CaO≦10 mol %. In still another embodiment, the alkali aluminosilicate glass comprises, consists essentially of, or consists of: about 64 mol % to about 68 mol % SiO₂; about 12 mol % to about 16 mol % Na₂O; about 8 mol % to about 12 mol % Al₂O₃; 0 mol % to about 3 mol % B₂O₃; about 2 mol % to about 5 mol % K₂O; about 4 mol % to about 6 mol % MgO; and 0 mol % to about 5 mol % CaO, wherein: 66 mol %≦SiO₂+B₂O₃+CaO≦69 mol %; Na₂O+K₂O+B₂O₃+MgO+CaO+SrO>10 mol %; 5 mol % MgO+CaO+SrO≦8 mol %; (Na₂O+B₂O₃)−Al₂O₃≦2 mol %; 2 mol %≦Na₂O−Al₂O₃≦6 mol %; and 4 mol %≦(Na₂O+K₂O)−Al₂O₃ 10 mol %. In other embodiments, the glass substrate comprises SiO₂, Al₂O₃, P₂O₅, and at least one alkali metal oxide (R₂O), wherein 0.75≦[P₂O₅(mol %)+R₂O (mol %))/M₂O₃ (mol %)]≦1.2, where M₂O₃=Al₂O₃+B₂O₃.

The glass article and methods described hereinabove may, in some embodiments, may be used to form a cover glass for consumer electronics applications, such as televisions, information terminals (IT), and hand-held devices such as communication devices, entertainment devices, or the like.

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

1. A glass article, the glass article comprising:
a chemically strengthened transparent glass substrate; and
an antireflective layer disposed on a surface of the transparent glass substrate, the antireflective layer comprising a plurality of nanoparticles, wherein the antireflective layer has a minimum reflectance of less than about 2% between about 400 nm and about 800 nm.

2. The glass article of claim 1, wherein the plurality of nanoparticles comprises hollow nanospheres and hollow nanosphere fragments.

3. The glass article of claim 2, wherein the hollow nanospheres and hollow nanosphere fragments comprise silica.

4. The glass article of claim 1, wherein the transparent glass substrate is strengthened by ion exchange.

5. The glass article of claim 1, wherein the transparent glass substrate comprises at least one of a soda lime glass, an alkali aluminosilicate glass, and an alkali aluminoborosilicate glass.

6. The glass article of claim 1, wherein the antireflective layer has a thickness in a range from about 2 nm to about 250 nm.

7. The glass article of claim 1, wherein the antireflective layer has a minimum reflectance of less than about 1.5% between about 400 nm and about 800 nm.

8. The glass article of claim 1 wherein the glass article is a cover glass for a television, information terminal, or a hand-held electronic device.

9. A method of strengthening a glass article, the method comprising:
contacting the glass article with an ion exchange medium, the ion exchange medium comprising potassium nitrate and at least 5 wt % potassium nitrite; and
forming a compressive stress layer extending from at least one surface of the glass article to depth of layer in the glass.

10. The method of claim 9, further comprising forming an antireflective layer on at least one surface of the glass article, the antireflective layer comprising a plurality of nanoparticles.

11. The method of claim 10, wherein the plurality of nanoparticles comprise a plurality of nanospheres and nanosphere fragments.

12. The method of claim 10, wherein the antireflective layer has a minimum reflectance of less than about 1.5% between about 400 nm and about 800 nm after forming the compressive layer.

13. The method of claim 10, wherein forming the antireflective coating comprises:
coating the surface with a dispersion comprising the plurality of nanoparticles and a binder; and
curing the dispersion to form the antireflective layer.

14. The method of claim 13, wherein the nanoparticles comprise nanospheres having a polymeric core and an outer shell comprising an inorganic oxide, and wherein curing the dispersion removes the polymeric core and forms hollow nanospheres and fragments of hollow nano spheres.

15. The method of claim 10, wherein forming the antireflective coating precedes immersing the glass article in the ion exchange bath, and wherein the reflectance of the antireflective coating, after immersing the glass article in the ion exchange bath, degrades by less than about 5%.

16. The method of claim 9, wherein contacting the glass article with an ion exchange medium comprises immersing at least a portion of the glass article in molten salt bath.

17. The method of claim 16, wherein the molten salt bath is heated at a temperature in a range from 390° C. to 550° C.

18. The method of claim 9, wherein the glass article is a cover glass for a television, information terminal, or a hand-held electronic device.

19. An ion exchange medium comprising potassium nitrate and at least 5 wt % potassium nitrite.

20. The ion exchange medium of claim 19, wherein the ion exchange bath comprises from about 5 wt % to about 85 wt % potassium.

21. The ion exchange medium of claim 19, further comprising up to about 5 wt % silicic acid.

22. The ion exchange medium of claim 19, wherein the ion exchange medium is a molten salt bath.

23. The ion exchange medium of claim 19, wherein the molten salt bath is at a temperature in a range from 390° C. to 550° C.
